(19) United States
(12) Patent Application Publication
(10) Pub. No.: US 2003/0212568 A1
(43) Pub. Date: Nov. 13, 2003

(54) Method for measuring mutual understanding

(76) Inventor: Ian Oliver, Chillingham (AU)

Correspondence Address: Dr Ian Oliver, PO Box 19, Chillingham, 2484, AU

(21) Appl. No.: 10/142,407

(22) Filed: May 10, 2002

(51) Int. Cl. G06F 17/60

(52) U.S. Cl. 705/1

(57) ABSTRACT

This invention pertains to the measurement of mutual understanding between cooperating participants, and for facilitating productive change, based on the results. It incorporates new measures, based on three independent types of cognitive conflict (pseudo, overt and hidden), and cognitive consensus. The measures are applied to issues elicited from participants. The issues are represented as bipolar hypotheses, and measured by capturing people's own viewpoints, and their predictions of others' viewpoints, using a rating scale. “Fuzzy” responses, indicated by selecting more than one point on the rating scale, are permitted. A fifth measure, cognitive uncertainty, is used for handling fuzzy responses. The method uses 100% of the information in questionnaire responses, partitioning predictions into the five components of mutual understanding. The invention is useful to consultants, facilitators and counsellors, facilitating the identification and resolution of issues, with groups of two or more people in personal relationships, communities, organizations, or elsewhere.

### CROSS-REFERENCE TO RELATED APPLICATIONS

Not applicable.

### STATEMENT REGARDING FEDERALLY SPONSORED RESEARCH OR DEVELOPMENT

Not applicable.

### COMPACT DISK APPENDIX

Not applicable.

### BACKGROUND OF THE INVENTION

This invention pertains to the measurement of mutual understanding between cooperating participants, and for facilitating productive change, based on the results.

B1 The Need

B1.1 Much time and effort is expended in corporations and government to address the issue of one-way or top-down communication. When the focus is external to organizations, or is across teams within organizations, communication and marketing strategies are designed and implemented. Various techniques, used for example by market researchers, opinion surveyors, electoral pollsters, culture analysts, and even marketing and sales departments, have been developed to measure the impacts of communication strategies. Such techniques more or less adequately assess the extent to which this kind of communication has been successful.

B1.2 The focus of this invention is on two-way communication between individuals or groups. Considerable resources are allocated by organizations to improving team functioning. Managers devote much time to dealing with team “issues”. Training and development budgets are allocated to addressing not just technical skills but also abilities in interpersonal relations. Examples of the latter include communication skills training, conflict resolution, team building, and personal growth (often using tools such as Myers-Briggs Type Indicator, Enneagram, Belbin's Team Roles, Team Management Index, 360 Degree Feedback, and hundreds of similar devices). In large part, the aim of interpersonal relations development is to increase people's insight into themselves and their colleagues, with the intention of improving their ability to communicate, and hence to increase their collective productivity.

B1.3 Since about the 1980s, professional facilitators have been used increasingly by organizations, to manage group discussions, seminars or conferences—systematically addressing organizational issues while managing the interpersonal dynamics. Overtly, such facilitated discussions deal with substantive issues and (where successful) produce jointly agreed decisions and plans of action. Covertly, facilitators simultaneously coach groups to some degree in communication skills, conflict resolution, team building and perhaps personal growth. In other words, a large part of the work of facilitators is aimed at increasing mutual understanding within groups.

B1.4 Questions about the effectiveness of facilitators, and indeed the effectiveness of communication skills training and team building are difficult to answer definitively. That is, there are no suitable tools for data-based measurement of the insight people have into their colleagues' views of the world, that is, of their mutual understanding. Facilitators and managers measure the effectiveness of facilitation, communication skills training, and team building, by post hoc anecdotal evidence and personal judgment. There is a need to obtain objective information about mutual understanding with respect to everyday organizational issues, as part of the process of addressing those issues. There is no system currently available for that purpose.

B1.5 This invention is a method for addressing issues that are most relevant at a point in time to an organization, community or personal relationship, while simultaneously measuring the degree of mutual understanding in these relationships. The invention permits substantive issues and interpersonal relationships to be addressed simultaneously, using objective data. The outcomes of using this invention provide verifiable information, both about the issues and about interpersonal perceptions. The invention can be supplemented with reports concerning the decisions made as a result of dialogue about the data.

B1.6 The above points are focused on applications in organizations, but the invention is just as applicable to personal therapy, relationship counselling, community development, and international diplomacy.

B2 Definition of Mutual Understanding

B2.1 Mutual understanding is defined, for the purposes of this invention, as the extent to which members of a group of people know the personal constructions of other members of the group. The technical term in italics is based on Personal Construct Theory (PCT), which was developed by G. A. Kelly (1955). Personal constructs subsume opinions, beliefs, attitudes, values, and the like. Personal constructions comprise interpretations people make about their environment, and the hypotheses they form about past, current and forthcoming events. Personal constructions, according to PCT, determine the actions people take.

B2.2 PCT encompasses key concepts for the measurement of mutual understanding, including individuality (idiosyncratic construction of events), commonality (similarity of event construction) and sociality (construction of others' constructions). The invention is built upon this foundation. It also relies on Kelly's dichotomy corollary, which indicates that the full meaning of events is derived by considering not just what they are, but also what they are not. Finally, Kelly's choice corollary underpins the process within which the invention is intended to be embedded, which culminates in decision-making and action.

B3 Previous Difficulties

B3.1 Many attempts have been made to assess the extent to which people mutually understand each other's viewpoints, but such attempts have been subject to methodological flaws. There is no prior substantiated method for comparing and contrasting viewpoints of members of a group with the predictions or expectations of those viewpoints by other members of the group. Several difficulties have contributed to lack of success in measuring mutual understanding:

a) Previous attempts to measure mutual understanding have invariably addressed content material, i.e. issues, supplied by the investigator, or strongly influenced by the investigator. By definition, “mutual” understanding implies a focus on issues that are highly relevant to the participants whose mutual understanding is being measured. Therefore, the issues ought not to be imposed by the investigator. Prior research into the systematic elicitation of relevant issues from the participants, in a form suitable for measurement of mutual understanding, is minimal. Only Kelly (1955) has produced a widely accepted quasi-scientific technique for the process. Even his useful repertory grid is highly restricted in its applicability.

b) In any human group there are always issues of privacy and trust, which enable or prevent people from discussing issues of significance to them. To measure mutual understanding, an investigator needs a methodical approach to (1) increasing the trust of participants, (2) lowering their defensiveness, and finally (3) eliciting the issues about which mutual understanding is to be measured. Informal processes are used routinely for identifying and addressing issues so that groups of people can solve them. On the other hand, there is no systematic process for doing this to facilitate the measurement of mutual understanding.

c) There can be a great deal of administrative overhead in enabling participants to provide their own opinions and their predictions of others' views, and in tracking and analyzing the responses, when there are several people involved. A simple and practical system is needed for this.

d) There is no suitable theory enabling the comparison and contrast of views and predictions in a systematic manner, using sound constructs that are free from known imperfections. Previously used theory has been recognized as inadequate for many years—a point that is discussed in more detail below.

e) It has not been possible, largely because of the above problems, to provide accurate and meaningful numerical results, which summarize the degree of mutual understanding, issue-by-issue, or in aggregated form across sets and sub-sets of issues.

B4 Data Representation

B4.1 The invention collects data from participants using a specially constructed questionnaire. We briefly describe some well-known problems with questionnaires, which are addressed by the invention.

B4.2 Questionnaires are routinely used to assess opinions, attitudes, beliefs and values. In one format relevant to this invention, questionnaire items may be expressed as propositions, conjectures or hypotheses, with which respondents are asked to agree or disagree. The main problems with typical questionnaires are (1) that the wording and intent of items are often not precisely attuned to respondent experience, and (2) that the respondent may be puzzled about the implied opposite or alternative to a stated proposition, conjecture or hypothesis, and therefore be unsure of the deep meaning of the questionnaire item. Such problems diminish the value and meaningfulness of questionnaire responses to the measurement of mutual understanding.

B4.3 Rating scales are often used to determine respondents' degree of agreement or disagreement. The number of scale intervals may range from two to eleven, and sometimes a greater number. Statistical analysis of responses usually provides overall summaries of viewpoints, either item-by-item, or aggregated across all items or subsets of items. The key problem is that a response on any one point of a rating scale may incorrectly indicate a more definitive opinion than is the case. Particularly when predicting opinions of other people's views, respondents need a facility to provide fuzzy responses. That is, they need to be able to indicate the extent to which they are either uncertain about their viewpoint, or wish to indicate a range of scale points as their response for other reasons.

B4.4 Common practice in questionnaire design permits respondents to leave an item blank, or to mark a Don't Know category, in a number of circumstances. These include when the respondent (1) has no opinion on the issue, (2) prefers not to disclose an opinion, (3) finds the issue irrelevant, or (4) does not understand the issue. Questionnaires containing non-responses of this kind introduce significant complications in statistical analysis. A suitable method of eliminating non-responses would greatly simplify statistical analysis.

B5 Invalidity of Prior Theory

B5.1 Consider two people Alice and Bob. Early research in person perception attempted to measure, for example, Alice's “ability to predict accurately”. That was allegedly measured by comparing Alice's prediction of Bob's opinion with Bob's actual opinion. If the prediction by Alice was equal to Bob's actual opinion, researchers inferred from that result alone that Alice had the ability to predict Bob's view accurately. An alternative explanation is that Alice merely assumed that Bob was just like her, fortuitously happened to have a similar opinion to Bob's opinion, and may in fact have had poor predictive ability.

B5.2 Measures like this, which compare one perspective with one other perspective, so-called “dyadic” measures, were long ago shown to confound variables or permit ambiguities of interpretation (Cronbach, 1958). Dyadic measures continued to be used for years after the warnings were issued (e.g. by Hammond 1965, Newcomb, Turner and Converse, 1965, Laing, Phillipson and Lee, 1966, Rowe and Slater, 1976, Ryle and Lunghi, 1971).

B5.3 Subsequently, research into mutual understanding declined because of these difficulties. Nevertheless, dyadic measures from Laing's interpersonal perception method are still being actively promoted on the Internet (Kenny, 2002).

B5.4 A sociological model of consensus proposed by Scheff (1967) was used by Oliver (1983) as a basis for proposing “tetradic” measures of mutual understanding, using four perspectives simultaneously (Alice and Bob's opinions, and their predictions of each other's opinions). Alperson (1983), a researcher into the social psychology of mutual understanding, made the following comment about Oliver's model: “The development of the conceptual representation of the interactions of Understanding and Agreement in terms of consensus, overt conflict, pseudo conflict, and hidden conflict is of major importance. It is elegant and parsimonious.”

B5.5 While being free of many of the difficulties inherent in dyadic measures, the tetradic measures focused too much on group responsibility for mutual understanding, and did not adequately take into account each individual's contribution. The tetradic measures were therefore also inadequate for the purposes of this invention.

B5.6 In the period 1983 to 2002, the inventor developed the triadic measures, which are satisfactory from all points of view. In order to demonstrate practical usefulness, the inventor has produced a computer program TeamMAP (Oliver, 2002) as an implementation or embodiment of the invention described in this document.

### B6 REFERENCES

Alperson, B. L. (1983). Examiner's report on PhD thesis submitted by Ian Oliver. Griffith University, Brisbane.

Cronbach, L. J. (1958). Proposals leading to analytic treatment of social perception scores, in Tagiuri & Petrullo, 353-379.

Kenny, D. A. (2002). Interpersonal perception: nine basic questions. http://w3.nai.net/˜dakenny.

Hammond, K. R. (1965). New directions in research on conflict resolution. The Journal of Social Issues, 21(3), 44-66.

Kelly, G. A. (1955). The psychology of personal constructs. New York: Norton.

Newcomb, T. M., Turner, R. H., and Converse, P. E. (1965). Social psychology: the study of human interaction. London: Routledge & Kegan Paul.

Laing, R. D., Phillipson, H., and Lee, A. R. (1966). Interpersonal perception. London: Tavistock.

Oliver, I. (1982). Mutual understanding. PhD thesis, Griffith University, Brisbane.

Oliver, I. (2002). TeamMAP. http://www.TeamMAP.com.

Rowe, D., and Slater, P. (1976). Studies of the psychiatrist's insight into the patient's inner world, in Slater (1976), 123-144.

Ryle, A., and Lunghi, M. (1971). A therapist's prediction of a patient's dyad grid. British Journal of Psychiatry, 118, 555-560.

Scheff, T. J. (1967). Towards a sociological model of consensus. American Sociological Review, 32(1), 32-46.

Slater, P. (1976). Explorations of intrapersonal space. London: Wiley.

Tagiuri, R., and Petrullo, L. (1958). Person perception and interpersonal behavior. Stanford: Stanford University Press.

### BRIEF SUMMARY OF THE INVENTION

S1 Many computer systems have been developed for surveying perceptions, attitudes, culture, and the like. Such systems tend to focus on common agreement or the lack of it, and do not directly and systematically attempt to capture people's perceptions or expectations of each other's viewpoints. That is, there have been no general systems or methods, which measure mutual understanding between people using theoretically sound measures.

S2 The invention provides a robust method and system by which mutual understanding may be measured and used in enhancing team functioning. In doing so, it solves the following problems:

a) adequate theory for measuring mutual understanding,

b) representing deep meaning of issues, rather than superficial meaning,

c) a facility for respondents to indicate uncertainty, or a non-specific viewpoint,

d) eliminating the need for special consideration of non-responses during analysis.

### BRIEF SUMMARY OF THE SEVERAL VIEWS OF THE DRAWINGS

Not applicable.

### DETAILED DESCRIPTION OF THE INVENTION

D1 Introduction

D1.1 The invention is a method comprising four components:

a) capturing and representing issues in a precise manner,

b) obtaining accurate data from participants,

c) analyzing the data using adequate theoretical constructs, and

d) presenting the results of the analysis in a meaningful and useful form.

D1.2 When an investigator “intervenes” in an organization, to measure mutual understanding, the four components of the method are best embedded in a range of other strategies. A process implementing the invention would include such strategies as clarification, negotiation, conflict resolution and decision-making. Strategies of this kind are referred to in this description to enhance clarity, and to put the invention in its context, but are not part of the invention.

D2 Representation of Issues

D2.1 To enable an investigator to explore participants' personal constructions, their cooperation is essential. The investigator must reply on self-reports of constructions, because such constructions are not directly observable. Accurate self-disclosure of personal constructions is most likely when the investigator has created an atmosphere of trust, safety, and where appropriate, confidentiality.

D2.2 Cooperation is gained by negotiating agreement on a range of topics that will be included in the exploration of mutual understanding. For example, a topic might be “team roles”. By implication, or by express agreement, topics to be excluded from the agreed range of topics are also defined during the same negotiations.

D2.3 During discussions with participants, issues are converted into the form of opposing propositions, conjectures, or hypotheses, following Kelly (1955). An example under the heading “team roles” might be “team members are clear about their roles and responsibilities” versus “team members are confused about their roles and responsibilities”. Further, the issues are prepared by negotiation with the participants. The measurement process does not start until authoring participants have agreed upon both hypotheses for their authored issues (where such authors may be individuals or groups).

D2.8 The content of the questionnaire is developed by the participants, and is not tied to any underlying theory about the subject matter imposed by the investigator. The investigator facilitates the elicitation process. Essential to the process are the integrity and self-awareness of the investigator, and his or her public disclosure of any interest in the subject matter that might introduce bias.

D2.4 It is common practice for questionnaires to present pairs of items as opposing ideas, and to require respondents to choose one or the other, or to allocate a number of votes to one or the other. For example, a questionnaire containing the forced choice “I like skiing” versus “I like football” might require the respondent to weigh up the two alternatives and decide the extent to which one is preferred to the other. The forced choice method typically presents two different ideas, and asks the respondent to choose between them.

D2.5 In this invention, the opposing hypotheses comprise just one idea. The skiing and football example could be presented as two hypothesis pairs “I like skiing” versus “I do not like skiing” and “I like football” versus “I do not like football”. In this way, the invention captures people's construction of events in accordance with PCT. If a participant offers hypotheses that are clearly not opposites, the investigator assists the participant to tease out the relevant constructions. For example, a participant might offer “we need to do some planning” versus “we need to discuss the issues”. The investigator tests for opposites by asking whether a participant could potentially agree with both hypotheses simultaneously. If so, the hypothesis pair is not a pair of opposites, as is the case in this example, and contains more than one construction. The hypothesis pair might be refined to “we need to do some planning” versus “planning is not needed at present”, and “we should discuss the issues” versus “the issues do not need further discussion”.

D2.6 Typically, a questionnaire is developed by a third party, tested in a pilot study, and refined by the third party until certain measures of validity and reliability are satisfied. In this invention, validity and reliability are established by dialogue with the respondents to the questionnaire, and not by numerical calculations, or other quasi-objective methods. That is, the questionnaire is considered valid when participants agree that hypothesis pairs comprise true opposites, and accurately represent the issues about which they wish to measure mutual understanding.

D2.7 The textbook reason for minimizing communication between investigator and respondent before measurements are taken, is to reduce the likelihood of bias, stemming from the influence of the investigator's personal constructions. Bias is a form of distortion, in which results obtained from a study do not accurately reflect the matter under study. In the invention, effective communication between investigator and participants is maximized, so that all parties achieve mutual understanding on the questionnaire development and administration process. The investigator does not influence the content, other than to ensure that hypotheses are represented as unambiguous true opposites as perceived by participants.

D2.9 Further, participant bias is minimized, because all questionnaire items are framed as bipolar opposites. The investigator negotiates with each participant author, to make sure that both poles of items are meaningful to all participants, and that the representation does not “lead” participants when answering the questionnaire. It is possible for the investigator to discuss hypothesis pairs with participants before the questionnaire is administered, without revealing any particular participant's point of view. The only thing that is revealed is the subject matter of the questionnaire items. Thus, participants contribute to questionnaire design, without influencing respondents towards any participant's personally desired outcomes.

D2.10 Clearly, the invention has much in common with action research, where the measurement process has an impact on what is being measured. The negotiation process may change some participants' constructions of the issues, as understanding increases. Measurements produced by the invention will not assess the state of mutual understanding as it was before the measurement process started. On the other hand, objective information about the degree of mutual understanding at the time of questionnaire completion will be obtained, in the form of verifiable quantified data for analysis and discussion. Although the method changes the state of mutual understanding, the measurements produced are nevertheless meaningful and useful snapshots of the participants' constructions at a clearly identified point in time.

D3 Representation of Viewpoints

D3.1 Data collection about issues is best described using an example. We continue to consider the mutual understanding between two people Alice and Bob, and focus on a single issue represented in bipolar form (such as the example “team members are clear about their roles and responsibilities” versus “team members are confused about their roles and responsibilities”). Each pole of the issue is a proposition, conjecture or hypothesis. The two poles are seen by participants as logical “opposites”, in the sense that a participant cannot agree with both poles. Consistent with PCT, the bipolar representation presents the deep meaning of a single idea, not a juxtaposition of two separate ideas expressed more superficially.

D3.2 Alice and Bob provide their own viewpoints on the issue, and predict each other's viewpoint. There are therefore four “perspectives” on the issue.

D3.3 In accordance with common practice, perspectives are captured using a rating scale, with any number of points. The rating scale is most conveniently presented horizontally between the two poles of the issue, the “left” and “right” poles, although other arrangements are possible. To indicate agreement with the left or right pole, a participant selects the left or right end of the rating scale respectively. To indicate a viewpoint intermediate between the left and right poles, the participant selects an intermediate position on the rating scale.

D3.4 The positional representation of viewpoints described above is easily converted into numerical form. A suitable implementation uses an eleven-point scale, representing viewpoints ranging from 100% agreement with the left pole and 0% agreement with the right pole, to 0% agreement with the left pole and 100% agreement with the right pole. The eleven points allow for an easily-described set of possible responses 100/0, 90/10, 80/20, 70/30, 60/40, 50/50, 40/60, 30/70, 20/80, 10/90, and 0/100. This representation is not claimed as new. It is described in detail, because the invention uses data collected in this manner.

D3.5 Let the symbol A represent Alice's viewpoint on the issue, where A is the percentage agreement Alice has with the left pole. Alice's agreement with the right pole is 100-A. Let B represent Bob's viewpoint, using the same approach. Let AB represent Alice's prediction of Bob's viewpoint, and let BA represent Bob's prediction of Alice's viewpoint.

D4 Components of Mutual Understanding

D4.1 To compare and contrast the four perspectives, we define components of mutual understanding, using two sets of functions of A, B, AB and BA. This invention introduces “triadic” measures, which compare three perspectives simultaneously, and which are shown here to be free of confounding effects. The two sets of measures partition the predictions AB and BA respectively into four components each. Each set compares the prediction AB or BA with the basic viewpoints A and B.

D4.2 Focusing just on Alice's prediction of Bob's response, we define the following components of mutual understanding:

a) Alice's cognitive consensus with Bob=c

b) Alice's cognitive pseudo conflict with Bob=p

c) Alice's cognitive overt conflict with Bob=o

d) Alice's cognitive hidden conflict with Bob=h

There are also two subsidiary components, used for intermediate computations:

Alice's cognitive consensus with Bob on the left hypothesis=c.left

Alice's cognitive consensus with Bob on the right hypothesis=c.right

The invention uses the following computational formulas:

c.left=min(A, B, AB)

c.right=min(100-A, 100-B, 100-AB)

c=c.left+c.right

p=min(A-c.left, B-c.left, 100-AB-c.right)+min(100-A-c.right, 100-B-c.right, AB-c.left)

o=min(A-c.left, 100-B-c.right, 100-AB-c.right)+min(100-A-c.right, B-c.left, AB-c.left)

h=min(A-c.left, 100-B-c.right, AB-c.left)+min(100-A-c.right, B-c.left, 100-AB-c.right)

D5 Invariance of Component Sum

D5.1 We now prove that c+p+o+h is invariably equal to 100. There are six possible combinations of values of A, B, and AB that we need to consider, one of which we will analyze in detail The six cases are A≧B≧AB,A≧AB≧B,B≧A≧AB,B≧AB≧A,AB≧A≧B, and AB≧B≧A. There are no other possible combinations.

D5.2 We consider the first of these cases, in which A≧B≧AB. By inspecting the computational formulas, it may be determined that:

c.left=AB

c.right=100-A

c=100-A+AB

p=min(A-AB, B-AB, A-AB)+min(0, A-B, 0)=B-AB

o=min(A-AB, A-B, A-AB)+min(0, B-AB, 0)=A-B

h=min(A-AB, A-B, 0)+min(0, B-AB, A-AB)=0

D5.3 From this, we see that c+p+o+h=100-A+AB+B-AB+A-B+0=100. Similar analyses with the other five combinations reveal that c+p+o+h=100 always. Therefore, it is appropriate to consider Alice's prediction (consisting of the response AB on the left hypothesis, and the implicit response 100-AB on the right hypothesis, which total 100) as being partitioned into four components c, p, o and h which total 100.

D5.4 It may be deduced that p, o and h are independent, and therefore suitable to use as theoretical variables. This overcomes a major problem in prior research, in which variables were not independent. However, only three of the four measures comprise an independent set. The three measures of cognitive conflict (pseudo, overt and hidden) are not independent of cognitive consensus, because the value of cognitive consensus is related linearly to cognitive conflict, being its value subtracted from 100.

D5.5 Similar analyses apply to Bob, his prediction BA also being partitioned into components c, p, o and h. There is no direct relation between the four components computed for Alice and the four computed for Bob.

D6 Interpretation of the Components

D6.1 There are four key definitions:

a) Cognitive consensus, c, measures the extent to which Alice has a similar view to Bob, and accurately predicts that similarity.

b) Cognitive pseudo conflict, p, measures the extent to which Alice has a similar view to Bob, but incorrectly predicts their views as dissimilar.

c) Cognitive overt conflict, o, measures the extent to which Alice has a different view to Bob, and accurately predicts that dissimilarity.

d) Cognitive hidden conflict, h, measures the extent to which Alice has a different view to Bob, but incorrectly predicts their views as similar.

D6.2 These definitions are descriptive in nature, and are not ones interpreted from another underlying theory. The definitions are naive and without deep semantics. They do not require validation against other theories or other constructs, because they merely describe what is evident rather than interpret it. This naivete is useful, in that it enables the investigator to report patterns of mutual understanding in simple terms to participants, without their needing to absorb and trust a deeper theory.

D6.3 Of significance is the absence of an “error” term. The predictions AB and BA are partitioned into components that exclude the need for an error term. To use statistical terminology, 100% of the “variation” in responses to the questionnaire is explained by the new components. Absence of error is supported by Kelly's work cited earlier, which indicates that participants in the process of measuring mutual understanding actively “construct” their responses and imbue them with meaning. They do not merely respond mechanistically. Consequently, responses are assumed to be meaningful error-free assertions by respondents, and are treated as such by this invention. In contrast to some other methods, responses are not assessed against an underlying model imposed by the investigator, such methods necessitating the use of an error term.

D7 Additional Components

D7.1 Four other components may also be derived. They are pre-existing dyadic measures, recalculated for bipolar hypotheses using sound formulas:

a) Cognitive similarity, s, also called “agreement” or “similarity of perception”

b) Cognitive dissimilarity, d

c) Cognitive accuracy, a, also called “perceptual accuracy, or “predictive ability”

d) Cognitive inaccuracy, i

D7.2 The values of these are calculated using the following computational formulas:

c.left=min(A, B)

c.right=min(100-A, 100-B)

s=c.left+c.right

d=min(A-c.left, 100-B-c.right)+min(100-A-c.right, B-c.left)

c.left=min(AB, B)

c.right=min(100-AB, 100-B)

a=c.left+c.right

i=min(AB-c.left, 100-B-c.right)+min(100-AB-c.right, B-c.left)

D7.3 The four subsidiary definitions are:

a) Cognitive similarity, s, measures the extent to which Alice and Bob have similar views, regardless of the accuracy or inaccuracy of Alice's prediction of Bob's view.

b) Cognitive dissimilarity, d, measures the extent to which Alice and Bob have different views, regardless of the accuracy or inaccuracy of Alice's prediction of Bob's view.

c) Cognitive accuracy, a, measures the extent to which Alice accurately predicts Bob's view, regardless of their similarity or difference of viewpoint.

d) Cognitive inaccuracy, i, measures the extent to which Alice's prediction of Bob's view is inaccurate, regardless of their similarity or difference of viewpoint.

D7.4 These four measures are not independent of c, p, o, or h. Some calculation along the lines of the above proof will demonstrate that s+d=100, and a+i=100. Further calculation reveals the intuitively obvious relationships s=c+p, d=o+h, a=c+o, and i=p+h (which may not hold when there are fuzzy responses, discussed below).

D7.5 These measures, although dyadic and to be used with caution, provide additional information to the investigator, in debriefing results with participants.

D8 Fuzzy Responses

D8.1 Participants need to be able to give responses that are less precise than selecting one of eleven points on a rating scale. A participant might form a view focused around several points of the rating scale, but feel it necessary to “guess” in selecting exactly one point. This invention removes the artificiality introduced by guessing, and accurately captures the imprecision of viewpoint.

D8.2 The invention permits the respondent to give a “fuzzy” opinion, by selecting more than one item on the rating scale. For example, if Alice thought that Bob's opinion was somewhere in the range 100/0 to 60/40, but could not pin it down any more precisely than that, she would select the five left-most points on the rating scale simultaneously. That is, she would select 100/0, 90/10, 80/20, 70/30, and 60/40 to indicate that her prediction was that Bob's view was somewhere in that range. Fuzzy responses can be given either for a respondent's own opinion, or for the prediction of another's opinion.

D8.3 A non-response is simply the most extreme case of a fuzzy response, where the range is 100/0 to 0/100. This will be shown to solve the statistical problems associated with non-responses.

D8.4 To discuss the range of a fuzzy response more precisely, we define Amax and Amin as the maximum and minimum rating scale scores Alice gives in her response to the left hypothesis of an issue. For example, if Alice's fuzzy response is the range 100/0 to 60/40 as described above, Amax=100 and Amin=60. Where the response is not fuzzy, Amax will be equal to Amin. The quantities Bmax and Bmin, and ABmax and ABmin have similar interpretations.

D8.5 A further component, cognitive uncertainty (symbol u), is introduced to deal with fuzzy responses. Where any of A, B or AB is a fuzzy response, we compute the values of the four components c, p, o and h for all possible combinations of responses that are implied in each of the fuzzy ranges. As we do this, we keep track of the minimum values of c, p, o, and h that are encountered. We record these minimum values as the measured values of c, p, o and h. They will not total 100, and so we add the cognitive uncertainty term to bring the total up to 100. Thus c+p+o+h+u=100.

D8.6 The values of the other four measures s, d, a and i, are also computed during this process, based on similar reasoning.

D8.7 We express this calculation process more precisely in pseudo-code as follows:

set minc = 100, minp = 100, mino = 100, minh = 100
set mins = 100, mind = 100, mina = 100, mini = 100
for A = Amin to Amax step Scale_Interval

for B = Bmin to Bmax step Scale_Interval

for AB = ABmin to ABmax step Scale_Interval

compute c, p, o, h, s, d, a, and i
if c < minc then set minc = c
if p < minp then set minp = p
if o < mino then set mino = o
if h < minh then set minh = h
if s < mins then set mins = s
if d < mind then set mind = d
if a < mina then set mina = a
if i < mini then set mini = i

end for

end for

end for
set c = minc, p = minp, o = mino, h = minh, u = 100 − (c+p+o+h)
set s = mins, d = mind, a = mina, i = mini

D8.8 This invention does not attempt to distinguish the different reasons for fuzzy responding. For example, no distinction is made between Alice being unwilling to disclose her viewpoint and having no particular opinion about the issue. Experience with other survey methods suggests that it is unwise to ask participants to assist in making such distinctions. (However, during the debriefing process, they may volunteer their reasons.) Participants may experience it as coercion, prying, or nit-picking, leading to frustration and potential non-cooperation in the measurement process. As explained earlier, participant cooperation is fundamental to the measurement process, and so we advise investigators to be willing to sacrifice a little precision in dealing with uncertainty, so as to ensure high precision in other areas.

D9 Groups

D9.1 The invention may be used with groups of people, rather than just with pairs of people. The invention calculates all results pairwise, thereby treating a group as a collection of pairwise relationships. For example, in a group of four people, Alice will give her own opinion on each issue, and predict the views of Bob, Claire, and Don. Similarly, Bob will give his own view, and predict the views of Alice, Claire and Don, and so on.

D9.2 It is also possible for one or more of the participants to be a group rather than an individual. For example, we could replace Claire by the Customer Service Team. Then, Alice, Bob and Don would predict the balance of opinion in the Customer Service Team. Members of the Customer Service Team would provide their own opinions, so that the invention can compare and contrast the predictions provided by Alice, Bob and Don with the computed balance of opinion for the Customer Service Team.

D9.3 Members of the Customer Service Team would also predict the balance of opinion among the other members of the team. The invention then calculates mutual understanding within the team, by considering each members own opinion, his or her prediction of the average of other team members' opinions, and the computed average of other team members' opinions.

D10 Aggregation

D10.1 We have described how to compute nine measures (c, p, o, h, u, s, d, a, and i) on a single issue. Clearly, it is possible to calculate weighted averages for each of these nine components separately, across sets of issues. For example, the investigator could determine the weighted average amount of cognitive consensus Alice has with Bob, over the domain of all issues, or over subsets of issues. Such averages are meaningful and useful in the debriefing process.

D10.2 It is intuitively apparent that weights need to reflect the importance, relevance, significance, or priority of issues to the participants. Different respondents may assign different weights to any given issue. However, as the nine measures are computed from one participant's point of view, each participant's own weights may be used in the computations.

D10.3 Experience indicates that investigators should not ask participants to assign weights to issues while responding to the questionnaire. Participants find that their perceptions of the importance, relevance, significance, or priority of issues can vary from moment to moment, as their attention shifts from personal needs, to those of the group, the organization, the human species, or the environment. Alternatives to explicit issue weighting are recommended.

D10.4 During the process of questionnaire development, while issues for the questionnaire are being proposed and negotiated, an implicit weighting process takes place. Conscious of time, and the effort required by all participants to answer the questionnaire, participants tend to limit their contribution of issues to those they regard as important, relevant, significant or of high priority.

D10.5 During questionnaire development, or after questionnaires have been analyzed, the investigator and participants can, if desired, decide upon categories that have different levels of importance, relevance, significance, or priority. Participants find it easier to place weights on categories than on individual issues. Issues can then be assigned to such categories.

D10.6 If desired, numerical results can be calculated using category weights as issue weights. This is not recommended, because of the additional complications introduced into the debriefing process. Although the numerical results, based on an assumption of equal issue weights, may be theoretically imprecise, investigators will be aware that the aim of the invention is to obtain practical outcomes. Absolute precision is impossible anyway with perceptual data, and the quest for precision is best halted at this point.

D10.7 A better approach is for an implementation to permit numerical results to be displayed category by category. In other words, issue weights need not be specifically sought or recorded, and can be assumed to be equal for computational purposes, the advantages of this approach outweighing the disadvantages.

D10.8 The invention permits results to be aggregated across people. For example, because we are able to compute the amount of cognitive consensus Alice has with Bob, Claire and Don separately, it is possible to compute the average amount of consensus she has with these group members. Similarly, from the amounts of cognitive consensus Bob, Claire and Don have with Alice, we can compute the average amount of cognitive consensus other group members have with Alice.

D11 Implications of Fuzzy Responses on Aggregation

D11.1 With this invention, there is no need for special account to be taken of “missing values” in analyzing the questionnaires. Using the concept of fuzzy responses, every questionnaire item receives a response. This seems intuitively appropriate, because the act of not responding to a questionnaire item is nevertheless a communication between respondent and investigator. Consequently, this invention assumes that, with cooperative participants, every questionnaire item receives a response, however fuzzy it may be.

D11.2 Aggregation is greatly simplified, because there is no need for the analysis program to count the number of non-responses on issues. The computed values of cognitive uncertainty, item-by-item, participant-by-participant, and in their aggregated forms, replace the traditional computations of numbers of responses and non-responses.

D11.3 In effect, this invention broadens the issue of non-responding from its previously black-and-white dichotomization, where there was either a response or there was not, to a wider view. Responses may fall anywhere on a continuum from complete certainty to complete uncertainty.

D12 Significance Tests

D12.1 This invention is designed as an idiographic, rather than a nomothetic, tool. Analysis of results does not use sampling statistics, which are suited to making inferences about a population based on a sample. Nevertheless, users of the invention will seek comparative information, whereby they can compare and contrast results with some absolute or relative indicators.

D12.2 An implementation of the invention should provide as a minimum the “results” that would be obtained if all the data were random numbers. Such results would occur if all participants gave their “opinions” and “predictions” by using a uniformly distributed random-number generator.

D12.3 Using an eleven-point scale with no cognitive uncertainty (i.e. u=0), the expected (average over an infinite number of random-number trials) “results” are c=500/11, and p=o=h=200/11. The significance levels for the other components are therefore s=a=700/11, and d=i=400/11.

D12.4 If a random degree of cognitive uncertainty is included in each perspective, the expected results are c=3615955/143748 (about 25.2), p=o=h=9230/3267 (2.8), u=9540485/143748 (66.4), s=a=14555/363 (40.1), and d=i=910/99 (9.2). These two sets of figures may be usefully described as the significance levels for (a) random perspectives without uncertainty, and (b) random perspectives with random uncertainty, respectively.

D12.5 The stated significance levels for c, p, o, and h in the absence of cognitive uncertainty were calculated by taking every possible combination of responses and averaging the computed values of c, p, o, and h respectively. A small computer program to accomplish this is simple to write, and is not included in this specification. The stated significance levels for c, p, o, and h in the presence of cognitive uncertainty were calculated by taking every possible combination of responses in every possible combination of maximum and minimum fuzzy response ranges, and averaging the computed values of c, p, o, and h respectively. A computer program to accomplish this is only slightly more complicated, and is also not included here.

D12.6 Because of the manner in which u is computed, it should be considered as significant if and only if none of c, p, o, or h is significant. If u=0, given that c+p+o+h=100, at least one of these four components will be significant in every case. Only when u is sufficiently large that none of c, p, o, or h is significant should cognitive uncertainty itself be regarded as significant.

D13 Presentation of Results

D13.1 The usefulness of this invention lies in the method by which the measures of mutual understanding described above are debriefed with the participants. An implementation should present results in two different tables, which ideally may be viewed simultaneously, but at least can easily be switched between. The first table should display scores aggregated over selected sets of issues. The second table should display item-by-item results for all of the issues in the selected set, for any pair of participants. The consultant, facilitator or counsellor should be able to select rapidly any subset of issues, and any pair of participants, to display the relevant results. He or she will switch between the overall scores in the first table, and the detailed pairwise results in the second table, to enable the group to explore the issues in their proper context, make decisions, and develop plans for action.

What I claim as my invention is:

1. A method for measuring mutual understanding in a mutually agreed domain of issues, between cooperating participants.

2. The method of claim 1, wherein each bipolar questionnaire item response is a fuzzy or non-fuzzy opinion or prediction as a contiguous set of between 1 and n+1 inclusive rating scale points on a scale of N points, where 0≦n<N, and fuzzy responses are those for which n>0.

3. A participant's prediction of another's opinion, in comparison with the participant's opinion and the other's opinion, all of claim 2, partitioned into five components of mutual understanding comprising (a) three independent components cognitive pseudo conflict, cognitive overt conflict, and cognitive hidden conflict, (b) the component cognitive consensus, and (c) the component cognitive uncertainty computed from fuzzy responses.

4. Aggregated measures for any component of mutual understanding of claim 3, calculated as averages, weighted or unweighted, over any subset of the questionnaire items.

5. Aggregated measures of mutual understanding of claim 4, assessed for significance by comparison with values that would have been obtained had the responses been random numbers.

6. Improvement of pre-existing dyadic measures of cognitive similarity, cognitive dissimilarity, cognitive accuracy and cognitive inaccuracy to encompass fuzzy responses of claim 2.
